(19) United States
(12) Patent Application Publication
(10) Pub. No.: US 2013/0179549 A1
(43) Pub. Date: Jul. 11, 2013

(54) INTELLIGENT METHOD OF BUILDING UP TELECOMMUNICATION NETWORK

(71) Applicants: Yi-Neng Lin, Hsinchu (TW); Wen-Te Chiang, Hsinchu (TW); Ping-Ju Li, Hsinchu (TW)

(72) Inventors: Yi-Neng Lin, Hsinchu (TW); Wen-Te Chiang, Hsinchu (TW); Ping-Ju Li, Hsinchu (TW)

(73) Assignee: FIBER LOGIC COMMUNICATIONS, INC., Hsinchu (TW)

(21) Appl. No.: 13/345,262

(22) Filed: Jan. 6, 2012

(51) Int. Cl. G06F 15/177

(52) U.S. Cl. 709/221

(57) ABSTRACT

An intelligent method of building up a telecommunication network is used to set a Network Element (NE) and an Element Management System (EMS) within an in-band/out-of-band network management framework. The method provides the network element with a random address and makes it connect to the element management system according to a default remote address. After successful connection, the element management system automatically sets up, manages, and allocates the network element. If the network element cannot connect to the element management system by itself, it may receive a Link Layer Discovery Protocol packet about successful connection via multicast generated from network elements nearby. The network may likewise acquire correct connection information about successful connection to the element management system. Thus, this invention allows a newly added network element to be quickly and automatically set in the telecommunication network.

### FIELD OF THE INVENTION

This invention relates to an intelligent method of building up a telecommunication network and particularly to a method of automatically building up a network element and an element management system in an in-band/out-of-band network management framework.

### BACKGROUND OF THE INVENTION

In the prior art, when a telecommunication network was built up, each newly added network element must be configured for being controlled and managed by a central master control end, such as an element management system.

However, when a lot of network elements are set, quite much human power and time is required. Namely, the cost of the human and time rises with the amount of network elements to be installed in equal proportion. In addition, the telecommunication network construction owner must bear the expenses for training the personnel to set up the network element.

Traditionally, when the network element is more requested, in addition to human increasing for support, the time of setting may also be prolonged to completely build up the telecommunication network. However, in the long run, the request of a flood of human is merely provisional but does not last for long time, and extremely long setting time will cause users' vilification and deceleration of the telecommunication network growth, all of which consume expenses and is inefficient.

In order to solve the imperfection of the prior art, a method of setting up the telecommunication network according to this invention is provided.

Consequently, because of the technical defects of described above, the applicant keeps on carving unflaggingly through wholehearted experience and research to develop the present invention, which can effectively improve the defects described above.

### SUMMARY OF THE INVENTION

The object of the present invention is to provide an intelligent method of building up a telecommunication network, which makes a Network Element (NE) newly arranged in the telecommunication network easily connect to an Element Management System (EMS) for achievement of quick and automatically building up telecommunication network.

The another object of the present invention is to provide above method, after the new network element is added to the telecommunication, the new element may easily and successfully connect to the element management system via another network element that have already successfully connect to the element management system.

The another object of the present invention is to provide above method, when the network element is ready to be connect to the element management system, a reserved random address area is used as an Internet Protocol Address (IP Address) for temporary connection to prevent the conflict (so called collision) from the network element and another network element in the telecommunication network during the setting.

The another object of the present invention is to provide above method, when the network successfully connects to the element management system, the network element multicasts a Link Layer Discovery Protocol (LLDP) packet to another network element in the telecommunication network to make the network element also successfully connect to the element management system by using the LLDP packet.

The another object of the present invention is to provide above method, the network element is enabled to receive the LLDP packet of another network element, which can successfully connecting to the element management system, the network element can no difficulty in connecting the element management system through the LLDP packet of another network.

The another object of the present invention is to provide the method in which the element management system is made to renew the marking status of the network element as active or inactive in the element management system at any time according to an alive message received from the network element.

To achieve the objects mentioned above, the present invention is provided an intelligent method of building up a telecommunication network, being used to set a Network Element (NE) and an Element Management System (EMS) within an in-band/out-of-band network management framework, the method comprising: Step (a) dividing an Internet Protocol Address (IP Address) into a random address area and a assigned address area; Step (b) storing a connection information to the network element to set the network element up a virtual local area network ID (VLAN ID), a network element ID (NE ID), a default local address, and a default remote address; Step (c) selecting the Internet protocol address among the random address area to be the default local address of the network element; Step (d) the network element provided with the default local address logging in the element management system according to the default remote address for establishing a network connection route path between the network element and the element management system; Step (e) the element management system transmitting an updated packet via the network connection route path to renew the connection information, and the default local address of the network element is updated according to the updated packet to change the Internet protocol address in the assigned address area; and Step (f) restarting the network element to connect to the element management system according to the updated connection address for completely building up the telecommunication network.

Compared with the prior art, the intelligent method of building up the telecommunication network is provided for the network element connecting to the element management system by itself, and the element management system sets up the network element and then establishing a connection route path between the network element and the element management system.

In addition, when the network element successfully connects to the element management system, the message of successful connection of the network element may be transmitted to another network element. Thus, another network element may also successfully connect to the element management system through analyzing the LLDP packet, such as the Internet protocol address and/or virtual LAN ID about the element management system.

Moreover, the system may determine whether the network element is arranged in the telecommunication network and dynamically keeps the marking status of message transmission in a database to make sure that the network element is in the telecommunication network through message transmission between the element management system and the network element.

### BRIEF DESCRIPTION OF THE DRAWINGS

FIG. 1 is a flow chart of an intelligent method of building up a telecommunication network in a first embodiment of this invention;

FIG. 2 is a flow chart of an intelligent method of building up the telecommunication network in a second embodiment of this invention;

FIG. 3 is a flow chart of an intelligent method of building up the telecommunication network in a third embodiment of this invention;

FIG. 4 is a flow chart of an intelligent method of building up the telecommunication network in a fourth embodiment of this invention; and

FIG. 5 is a flow chart of an intelligent method of building up the telecommunication network in a fifth embodiment of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

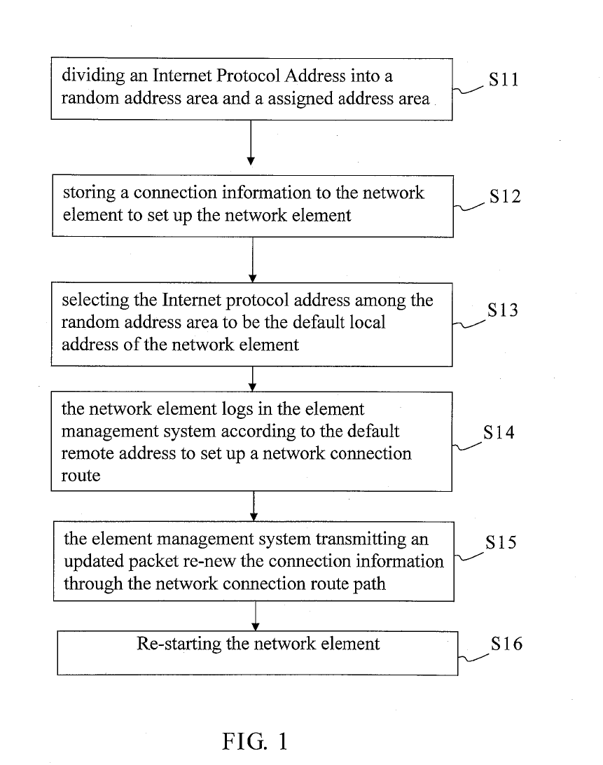

Refer to FIG. 1 as a flow chart of the intelligent method of building up the telecommunication network in the first embodiment of this invention. In FIG. 1, the intelligent method of building up the telecommunication network is used to set a network element and an element management system in an in-band/out-of-band network management framework. For example, the network element may be a data switch, and the element management system may be a network management server.

The method of building up the telecommunication network starts from step S11, dividing an Internet Protocol Address into a random address area and an assigned address area, such as the Internet protocol address starts from 192.168.0.0 to 192.168.0.255. In this step, the Internet protocol address starting from 192.168.0.0 to 192.168.0.20 is set as the random address area, and the Internet protocol address starting from 192.168.0.21 to 192.168.0.255 is set as the assigned address area.

Next step S12, storing a connection information to the network element to set the network element up a virtual local area network ID (VLAN ID), a network element ID (NE ID), a default local address, and a default remote address. Thus, the network element stores the connection information about the virtual local area network ID, the network element ID, the default local address, and the default remote address in advance.

The virtual local area network ID may be provided for network managers to manage for logical grouping of devices in different physical LANs, which guarantees complete information security of LAN management.

The network element ID is used for assurance of network uniqueness, such as a chassis ID, a MAC address, or another string.

The default local address indicates that when the network element is enabled, the network element connects to the Internet protocol address used by the telecommunication network. Further, the default remote address is the Internet protocol address of the element management system in the telecommunication network.

Next step S13, selecting the Internet protocol address among the random address area to be as the default local address of the network element. Hereupon, when the network element is starting, the network element selects an Internet protocol address from the random address area for making the Internet protocol address serve temporarily as the default local address, and thus the network element allows to be connected to the telecommunication network through the selected Internet protocol address. In the example taken from the description mentioned above, one of the areas of random address starting from 192.168.0.0 to 192.168.0.20 is also selected for being as the default local address.

Next step S14, the network element provided with the default local address logs in the element management system according to the default remote address for establishing a network connection route path between the network element and the element management system. Hereupon, the network element is connected to the telecommunication network according to the temporarily set as an Internet protocol address. Further, according to an address, which is guided to the element management system by the default remote address, the network element is made to connect (or log in) to the element management system. After the element management system accepts the login of network element, establishment of the network connection route between the network element and the element management system may be determined, and vice versa.

Further step S15, the element management system transmits an updated packet via the network connection route path to renew the connection information and the default local address of the network element is updated according to the updated packet to change the Internet protocol address in the assigned address area. The default local address of the network element is updated according to the updated packet to become the Internet protocol address in the assigned address area. Hereupon, when the element management system determines that the network element logs in, the element management system transmits the updated packet to update the connection information for the network element. The connection information at least comprises a new connection address for which the default local address of the network element is re-set through the assigned address area. For example, in the example taken from the description mentioned above, one of the areas of assigned address starting from 192.168.0.21 to 192.168.0.255 is also selected.

Next step S16, restarting the network element to connect to the element management system according to the updated connection address for completely building up the telecommunication network.

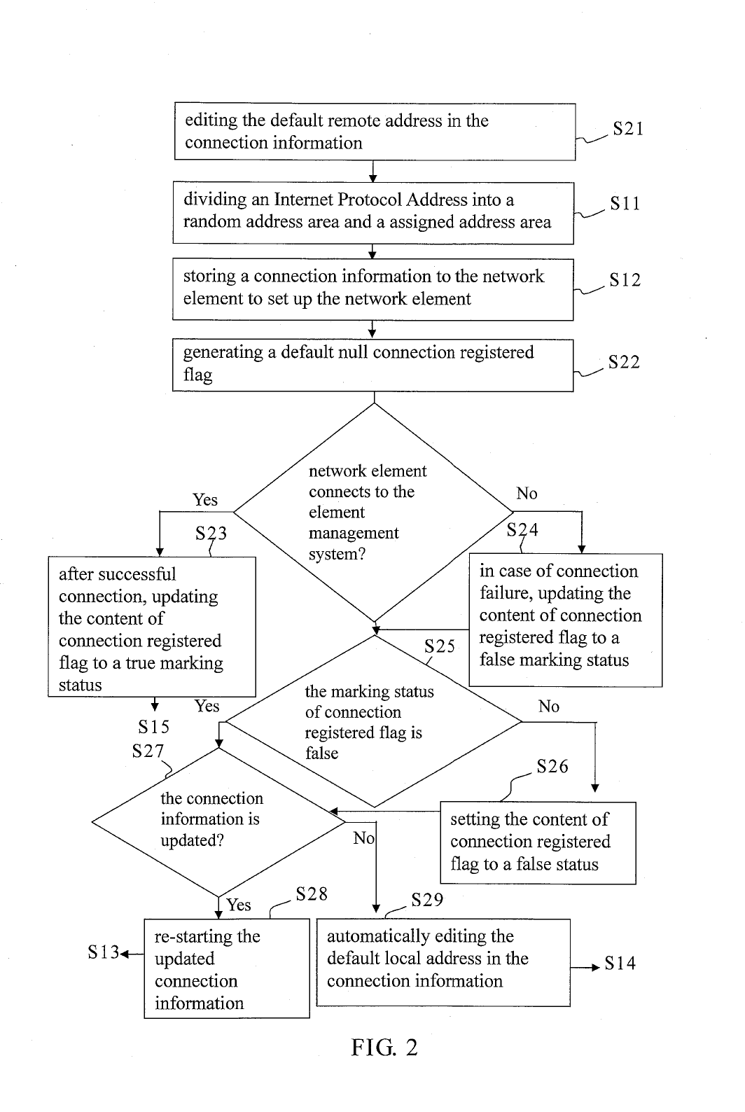

Refer to FIG. 2 as a flow chart of the method of building up the telecommunication network in a second embodiment of this invention. In FIG. 2, before step S11 the embodiment further comprises step S21, editing the default remote address in the connection information to provide for the network element connecting to the element management system via the edited default remote address. Hereupon, the connection information may be modified through an external edit. For example, a text file or firmware in the network element may be edited, which is called a manual mode, to modify the default remote address so that the network element may connect to the element management system according to the edited default remote address. It is remarkable that the step may be an embodiment of a means compensating the failure of automatic reach to the connection information.

Further, after step S12, an embodiment comprises step S22, generating a connection registered flag, wherein the connection registered flag is predetermined as a null marking status. According to the login status of network element, steps S23 and S24 are next implemented, separately.

In step S23, after the network element logs in to the element management system, the connection registered flag of network element is renewed as a true marking status according to the received update packet. In other words, after the network element successfully logs in to the element management system, the element management system transmits the updated packet and thus the connection registered flag of the network element is changed from the null marking status to the true marking status; then step S15 is implemented.

In addition, if the network element does not successfully log in to the element management system, step S24 is implemented, which indicates that the network element cannot log in to the element management system and is thus changed to the marking status as a false.

Next, the step of building up the telecommunication network further comprises step S25, determines whether the marking status of connection registered flag is false. According to the result of determination of the content of connection registered flag, steps S26 and S27 may be implemented, separately. In step S26, it is determined that the connection registered flag is the false marking status. The connection registered flag is further set to the false marking status and next step S27 is implemented. Otherwise, step S27 is implemented again, which further determines whether the connection is updated for steps S28 and S29 that will be implemented next.

In step S28, when the connection information is updated, the updated connection information is used to re-implement step S13.

In step S29, when the connection information is not updated, the default remote address of connection information is edited. Namely, from the determination, the failure of connection from the network element to the element management system is caused possibly by conflict of at least two network elements, in the telecommunication network, of which the addresses are the same, or by the wrong setting of default local address of the network element. Hereupon, through the automatic editing of the default local address of the connection information, the default local address in the connection information, which may be used to connect to the element management system, is updated so that the network element may be guided by the default local address to connect to a correct Internet protocol address of the element management system.

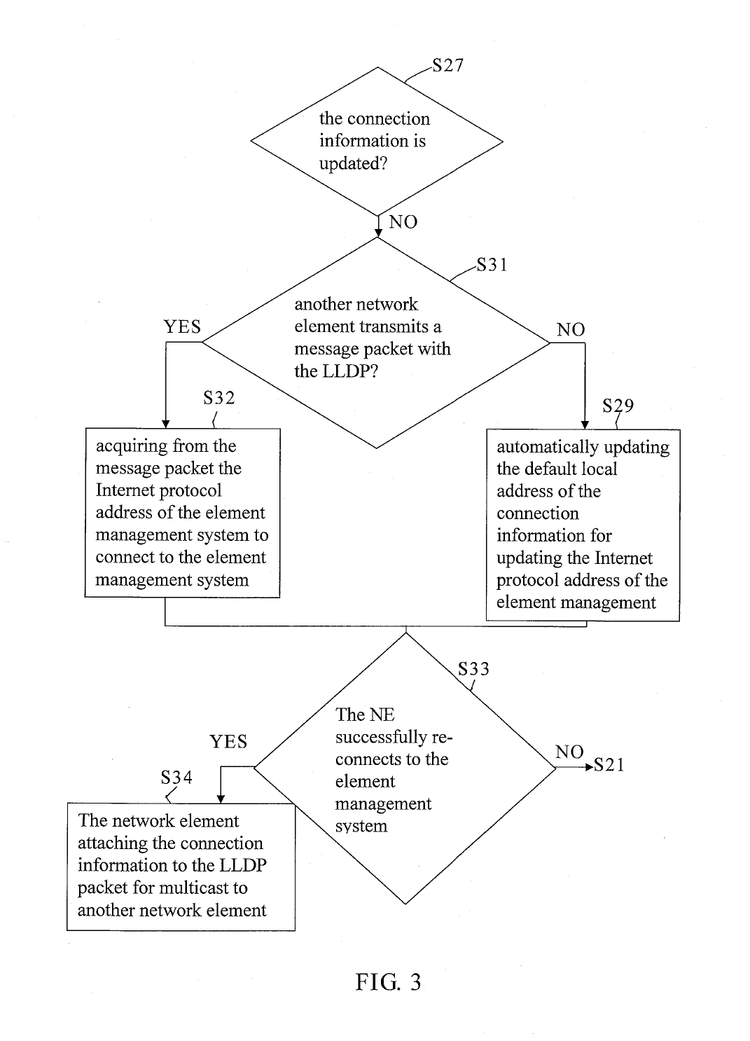

Refer to FIG. 3 as a flow chart of the intelligent method of building up the telecommunication network in a third embodiment of this invention. In FIG. 3 illustrating the method of building up the telecommunication network, after step S27, step S31 is next implemented, determining whether another network element transmits a message packet with the Link Layer Discovery Protocol (LLDP) or not. Hereupon, the network element may acquire the related connection information about successful connection to the element management system from the LLDP of another network element to update the connection information of the network element so that the network element may also connect to the element management system.

Accordingly, in step S32 followed by step S31, determining the network element transmits the message packet of LLDP, the network element acquires, from the message packet, at least one of the Internet protocol address and virtual LAN ID of the element management system to be connected to the element management system according to the Internet protocol address and the virtual LAN ID.

Alternatively, after step S31, step S29 immediately comes. In other words, when the network element does not receive the message packet of LLDP from another network element, step S29 keep running for automatically editing the default address of the connection information and then updating the Internet protocol address of the element management system.

Besides, in an embodiment, after steps S32 and S29, step S33 may come to determine whether the element management system is successfully connected or not. After the network element successfully connects to the element management system, step S34 comes, in which the network element attaches the connection information to the LLDP packet for multicast to another network element. In other words, after the network element successfully connects to the element management system according to the step mentioned above, the connection information about successful connection of the network element is likewise transmitted to the LLDP packet of another network element or a newly added network element in the telecommunication network for allowing the network element or the newly added network element to likewise successfully connect to the element management system by using the connection information provided by the network element. If connection fails, step S21 runs.

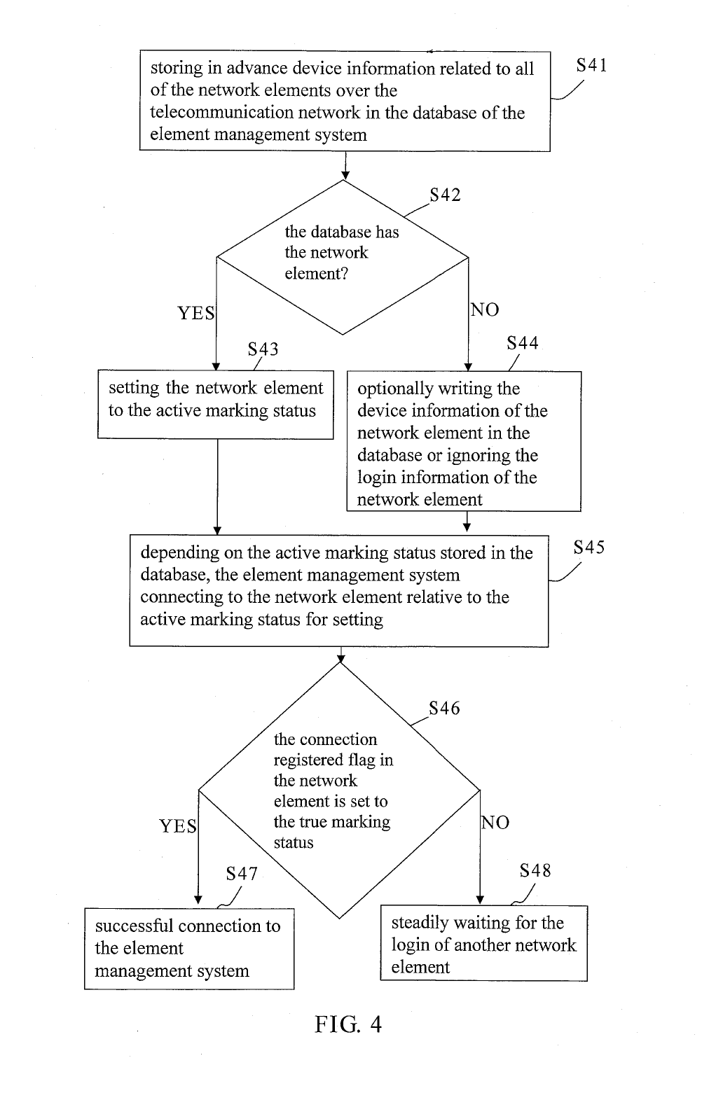

Refer to FIG. 4 as a flow chart of the intelligent method of building up the telecommunication network in a fourth embodiment of this invention. In FIG. 4 illustrating the method of building up the telecommunication network, a database is provided in the element management system, making the method have step S41, storing a device information associated with the network elements in the telecommunication network in the database of the element management system in advance. Hereupon, the device information related to the network element may be recorded/written in the database in a manual manner through a document or a user interface.

Further, after the network element logs in to the element management system, step S42 may be implemented, comparing the device information of the network elements with pieces of device information in the database to determine whether the device information about the network elements is stored in the database or not.

According to the comparison result, step S43 may further be implemented, when the device information of the network elements has stored in the database is determined, the marking status of the network element is set as active. Otherwise, step S44 is implemented, when the device information of the network elements is not stored in the database, the device information of the network element is selectively written in the database for setting the marking status of the network element as active or ignoring the register of the network elements directly.

Besides, whether after step S43 or step S44, step S45 is still implemented, depending on the active marking status stored in the database, the element management system is connected to the network element relative to the active marking status to set the network element.

Further, after step S45, step S46 may be included; determining whether the marking status of the connection registered flag in the network element is set as true after the element management system connects to the network element. After step S46, step S47 comes, in which if the connection registered flag is in the true status, then the network element successfully connects to the element management system. Otherwise, after step S46, step S48 comes, in which through the step mentioned in the embodiment mentioned above, the network element is finally allowed to automatically connect to the element management system.

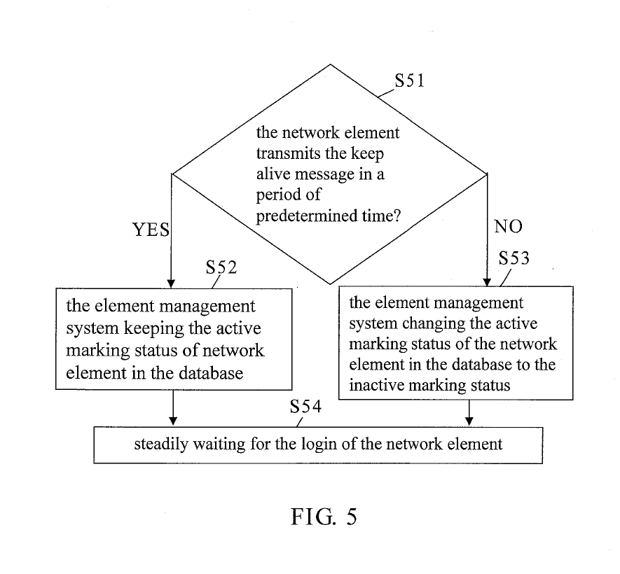

Refer to FIG. 5 as a flow chart of the intelligent method of building up the telecommunication network in a fifth embodiment of this invention. In FIG. 5, the method of setting up the telecommunication network further comprises step S51 in which the element management system determines whether the network element transmits an keep alive message during a period of determined time or not.

According to the result of determination in step S51, step S52 is next implemented, when the element management system receives the keep alive message from the network element within the period of determined time, the element management system keeps the marking status of network element in the database as active

Alternatively, in step S53, when the element management system non-receiving the keep alive message from the network element over the period of predetermined time, the element management system changes the active marking status of the network element in the database from active to the inactive.

Besides, after steps S52 and S53, performs step S54, the element management system steadily waiting for the network element to register.

Thus, the intelligent method of building up the telecommunication network allows the network element to be connected to the element management system by its own for making the system set up the network element and then establishing a connection route between the network element and the element management system.

In addition, when the network element successfully connects to the network element, the message of successful connection may be transmitted to another network element through the LLDP packet. Thus, another network element likewise may successfully connect to the element management system through the Internet protocol address (and the virtual LAN ID) about the element management system when the packet is analyzed.

Further, through message transmission between the element management system and the network element, the system may determine whether the network element is arranged in the telecommunication network and keeps the status of message transmission in a database for dynamically performing the update and making sure that the network element is in the telecommunication network.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An intelligent method of building up a telecommunication network, being used to set a Network Element (NE) and an Element Management System (EMS) within an in-band/out-of-band network management framework, the method comprising:
(a) dividing an Internet Protocol Address (IP Address) into a random address area and a assigned address area;
(b) storing a connection information to the network element to set the network element up a virtual local area network ID (VLAN ID), a network element ID (NE ID), a default local address, and a default remote address;
(c) selecting the Internet protocol address among the random address area to be the default local address of the network element;
(d) the network element provided with the default local address logging in the element management system according to the default remote address for establishing a network connection route path between the network element and the element management system;
(e) the element management system transmitting an updated packet via the network connection route path to renew the connection information, and the default local address of the network element is updated according to the updated packet to change the Internet protocol address in the assigned address area; and
(f) restarting the network element to connect to the element management system according to the updated connection address for completely building up the telecommunication network.

2. The intelligent method of building up a telecommunication network according to claim 1, wherein the default remote address is the Internet protocol address of the element management system.

3. The intelligent method of building up a telecommunication network according to claim 2, wherein before step (b) further comprising step (g) editing the default remote address in the connection information to provide the network element connecting to the element management system via the edited default remote address.

4. The intelligent method of building up a telecommunication network according to claim 2, wherein after step (b) further comprising step (h) generating a connection registered flag, wherein the connection registered flag is predetermined as a null marking status.

5. The intelligent method of building up a telecommunication network according to claim 4, wherein after step (h) further comprising step (i) after the network element logging in the element management system, the connection registered flag of network element is renewed as a true status according to the received update packet.

6. The intelligent method of building up a telecommunication network according to claim 4, wherein after step (h) further comprising step (j) after the network element cannot log in to the element management system, the network element changes the marking status of the connection registered flag is false.

7. The intelligent method of building up a telecommunication network according to claim 6, wherein after step (j) further comprising step (k) determines whether the connection registered flag is the false marking status.

8. The intelligent method of building up a telecommunication network according to claim 7, wherein after step (k) further comprising step (1) when the connection registered flag is the false marking status and the connection registered flag is further set as the false marking status.

9. The intelligent method of building up a telecommunication network according to claim 8, wherein after step (1) further comprising step (m) determine whether the connection information is updated or not; when the connection information is updated, the updated connection information is used to perform step (c); and when the connection information is not updated, the default remote address of connection information is edited automatically.

10. The intelligent method of building up a telecommunication network according to claim 9, wherein after step (m) further comprising step (n) determine whether another network element transmits a message packet with the Link Layer Discovery Protocol (LLDP) or not; when another network element transmits the message packet of LLDP, the network element acquires at least one of the Internet protocol address and virtual LAN ID of the element management system in the message packet from another network element, and the network element connects to the element management system according to the Internet protocol address and the virtual LAN ID; and when the network element does not receive the message packet of LLDP from another network element, the default local address of the connection information is automatically updated for updating the Internet protocol address of the element management system, and perform step (g) continuously.

11. The intelligent method of building up a telecommunication network according to claim 10, wherein after step (n) further comprising step (o) after the network element successfully is connected to the element management system, the network element attaches the connection information to the LLDP packet for transmitting to another network element via multicast.

12. The intelligent method of building up a telecommunication network according to claim 1, further comprising step: storing a device information associated with the network elements to the database of the element management system in advance.

13. The intelligent method of building up a telecommunication network according to claim 12, wherein after the network element logs in to the element management system, further comparing the step: comparing the device information of the network elements with the device information stored in the database to determine whether the device information of the network elements is stored in the database or not.

14. The intelligent method of building up a telecommunication network according to claim 13, further comprising a step: when the device information of the network element has stored in the database, the marking status of the network element is set as active; or further comprising a step: when the device information of the network elements is not stored in the database, the device information of the network element is selectively written in the database for setting the marking status of the network element as active or ignoring the register of the network elements directly.

15. The intelligent method of building up a telecommunication network according to claim 14, further comprising depending on the active marking status stored in the database, the element management system is connected to the network element relative to the active marking status to set the network element.

16. The intelligent method of building up a telecommunication network according to claim 15, further comprising a step: determining whether the marking status of the connection registered flag in the network element is set as true after the element management system is connected to the network element; when the marking status of the connection registered flag is true, the element management system sets up the network element by a setting packet; and when the marking status of the connection registered flag is false, the element management system steadily wait for another network element to register.

17. The intelligent method of building up a telecommunication network according to claim 15, further comprising a step: the element management system determines whether the network element transmits a keep alive message during a period of predetermined time; when the element management system receives the keep alive message from the network element within the period of determined time, the element management system keeps the marking status of network element in the database as active; and when the element management system non-receiving the keep alive message from the network element over the period of predetermined time, the element management system changes the active marking status of the network element in the database from active to the inactive.

18. The intelligent method of building up a telecommunication network according to claim 17, further comprising a step: the element management system steadily waiting for the network element to register.
